(19) United States
(12) Patent Application Publication
(10) Pub. No.: US 2006/0147096 A1
(43) Pub. Date: Jul. 6, 2006

(54) Fingerprint region segmenting apparatus, directional filter unit and methods thereof

(76) Inventors: Dong-jae Lee, Seoul (KR); Deok-soo Park, Seoul (KR)

Correspondence Address: HARNESS, DICKEY & PIERCE, P.L.C., P.O. BOX 8910, RESTON, VA, 20195, US

(21) Appl. No.: 11/324,380

(22) Filed: Jan. 4, 2006

(30) Foreign Application Priority Data
Jan. 5, 2005 (KR) 10-2005-0000807

(51) Int. Cl. G06K 9/00

(52) U.S. Cl. 382/124

(57) ABSTRACT

A fingerprint region segmenting apparatus and methods thereof The fingerprint region segmenting apparatus may include at least one directional filter receiving an input fingerprint image and filtering the input fingerprint image to generate at least one directional image, a normalization unit normalizing the at least one directional image and a region classification unit dividing the normalized at least one directional image into a plurality of blocks and classifying each of the plurality of blocks. In an example, the classification for each of the plurality of blocks may be one of a foreground of the input fingerprint image and a background of the input fingerprint image. In an example method, a fingerprint may be segmented by segmenting a fingerprint image into a plurality of regions based on a plurality of directional images, each of the plurality of directional images associated with a different angular direction.

### PRIORITY STATEMENT

This application claims the benefit of Korean Patent Application No. 10-2005-0000807, filed on Jan. 5, 2005, in the Korean Intellectual Property Office, the disclosure of which is incorporated herein in its entirety by reference.

### BACKGROUND OF THE INVENTION

1. Field of the Invention

The present invention relates generally to a fingerprint apparatus, directional filter and methods thereof, and more particularly to a fingerprint region segmenting apparatus, directional filter and methods thereof.

2. Description of the Related Art

Fingerprints may vary from person to person. Further, a fingerprint may not change throughout a person's life. Accordingly, fingerprints may be a useful tool for identification. Conventional fingerprint recognition systems may verify a person's identity, and may be included in, for example, an automated security system, a financial transaction system, etc.

In conventional fingerprint recognition systems, an input fingerprint image may include a foreground and a background. The foreground may refer to an area of the input fingerprint image including ridges. The ridges may indicate where a finger may contact a fingerprint input apparatus when the fingerprint may be made. The background may refer to an area that may not include ridge information, which may be a portion of the fingerprint image where a finger may not contact the fingerprint input apparatus when the fingerprint may be made.

Conventional fingerprint recognition systems may distinguish between the foreground and the background with fingerprint segmentation. The fingerprint segmentation may divide a given fingerprint image into a foreground and a background. The fingerprint segmentation may be performed at an initial stage of a fingerprint recognition process.

The fingerprint segmentation may enable other stages of the fingerprint recognition process, such as, for example, an extraction of ridge directions in the foreground, enhancement of foreground image quality and/or thinning of the foreground. Accordingly, the fingerprint segmentation may reduce a duration of the fingerprint recognition process and/or increase a reliability of the fingerprint recognize process.

However, errors may occur with respect to the information extracted from the background and/or the foreground. A fingerprint region segmenting process may reduce errors with respect to the background and/or the foreground. In the conventional region segmenting process, a brightness value in a given direction for each pixel of a fingerprint image (e.g., the background and/or the foreground) may be calculated. The fingerprint image may be divided into a plurality of blocks having a given pixel size (e.g., 16×16). The conventional region segmenting process may use a histogram distribution of the brightness values associated with the given directions in corresponding blocks to divide the fingerprint image into a plurality of regions.

However, if a given region in the plurality of regions has a uniform brightness, the direction for the given region may not be determined and the given region may not be divided correctly. Other conventional methods for determining a given fingerprint region may be based on a maximum response of a Gabor filter bank, reconstructing a fingerprint region, a consistency of ridge directions, a mean and variance of brightness of a fingerprint image, an absolute value of a ridge gradient calculated in given units and/or establishing a reliability metric based on information from neighboring blocks/regions.

However, each of the above-described conventional methodologies may be based on fixed threshold values which may filter a fingerprint image received from a given fingerprint input apparatus. Thus, if the given fingerprint apparatus is changed, the fixed threshold values may be less accurate, which may reduce an accuracy of a fingerprint region segmentation. In addition, other fingerprint characteristics (e.g., a humidity level or whether a fingerprint may be wet or dry) may vary between fingerprint images, which may further reduce the accuracy of the fingerprint region segmentation.

### SUMMARY OF THE INVENTION

An example embodiment of the present invention is directed to a fingerprint region segmenting apparatus, including a directional filter unit receiving an input fingerprint image and filtering the input fingerprint image to generate at least one directional image, a normalization unit normalizing the at least one directional image and a region classification unit dividing the normalized at least one directional image into a plurality of blocks and classifying each of the plurality of blocks.

Another example embodiment of the present invention is directed to a method of segmenting a fingerprint image, including filtering an input fingerprint image to generate at least one directional image, normalizing the at least one directional image, dividing the at least one normalized directional image into a plurality of blocks and classifying each of the plurality of blocks.

Another example embodiment of the present invention is directed to a method of segmenting a fingerprint image, including segmenting the fingerprint image into a plurality of blocks based on a plurality of directional images, each of the plurality of directional images associated with a different angular direction.

Another example embodiment of the present invention is directed to a directional filter unit, including a plurality of directional filters generating a plurality of directional images based on a fingerprint image, each of the plurality of directional images associated with a different angular direction.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention.

FIG. 1 illustrates an apparatus according to an example embodiment of the present invention.

FIG. 2(A) illustrates a directional gradient filter in a direction of 0° according to another example embodiment of the present invention.

FIG. 2(B) illustrates a directional gradient filter in a direction of 45° according to another example embodiment of the present invention.

FIG. 2(C) illustrates a directional gradient filter in a direction of 90° according to another example embodiment of the present invention.

FIG. 2(D) illustrates a directional gradient filter in a direction of 135° according to another example embodiment of the present invention.

FIG. 3 illustrates a histogram of a directional gradient image according to another example embodiment of the present invention.

FIG. 4(A) illustrates a brightness distribution of a fingerprint image received from different fingerprint input apparatuses with the same humidity level according to another example embodiment of the present invention.

FIG. 4(B) illustrates a brightness distribution of a given fingerprint image received from the same fingerprint input apparatus at different humidity levels according to another example embodiment of the present invention.

FIG. 4(C) illustrates a histogram comparing directional gradient images according to another example embodiment of the present invention.

FIG. 5(A) illustrates a normalized directional gradient image in a direction of 0° according to another example embodiment of the present invention.

FIG. 5(B) illustrates a normalized directional gradient image in a direction of 45° according to another example embodiment of the present invention.

FIG. 5(C) illustrates a normalized directional gradient image in a direction of 90° according to another example embodiment of the present invention.

FIG. 5(D) illustrates a normalized directional gradient image in a direction of 135° according to another example embodiment of the present invention.

FIG. 6(A) illustrates a fingerprint image prior to post-processing according to another example embodiment of the present invention.

FIG. 6(B) illustrates a resultant fingerprint image after post-processing according to another example embodiment of the present invention.

FIG. 7 is a flowchart of a fingerprint region segmentation process according to another example embodiment of the present invention.

FIG. 8 is a flowchart of a classification process according to another example embodiment of the present invention.

### DETAILED DESCRIPTION OF EXAMPLE EMBOIDMENTS OF THE PRESENT INVENTION

Hereinafter, example embodiments of the present invention will be described in detail with reference to the accompanying drawings.

In the Figures, the same reference numerals are used to denote the same elements throughout the drawings.

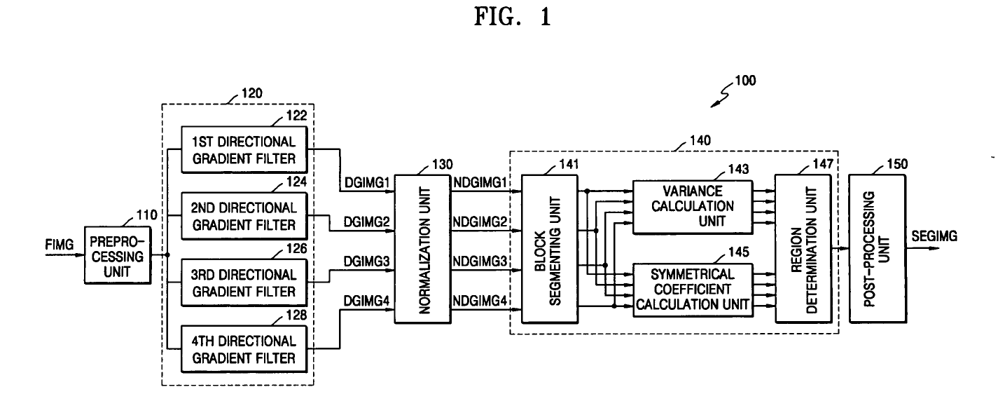

FIG. 1 illustrates an apparatus 100 according to an example embodiment of the present invention.

In the example embodiment of FIG. 1, the apparatus 100 may include a preprocessing unit 110, a directional gradient filter unit 120, a normalization unit 130, a region classification unit 140 and a post-processing unit 150.

In the example embodiment of FIG. 1, the preprocessing unit 100 may reduce noise in an input fingerprint image (FIMG). The preprocessing unit 110 may filter (e.g., with a Gaussian-filter) the FIMG to reduce noise (e.g., caused by discontinuous rapid changes in pixel values). In an example, if the preprocessing unit 110 uses a smaller Gaussian-filter, a lower amount of noise and/or a ridge component of the FIMG in the FIMG may be reduced. In another example, if the preprocessing unit 110 uses a larger Gaussian-filter, a larger amount of noise and/or a ridge component of the FIMG may be reduced. Thus, in another example embodiment of the present invention, a Gaussian filter size may be selected based at least in part on a noise and/or ridge component reduction characteristic.

In the example embodiment of FIG. 1, the directional gradient filter unit 120 may include a first directional gradient filter 122, a second directional gradient filter 124, a third directional gradient filter 126 and a fourth directional gradient filter 128 generating directional gradient images DGIMG1, DGIMG2, DGIMG3 and DGIMG4, respectively. In an example, the directional gradient images DGIMG1, DGIMG2, DGIMG3 and DGIMG4 may correspond to angular directions of 0°, 45°, 90°, and 135°, respectively. However, it is understood that other example embodiments of the present invention may include other angular directions associated with the directional gradient filters 122/124/126/128.

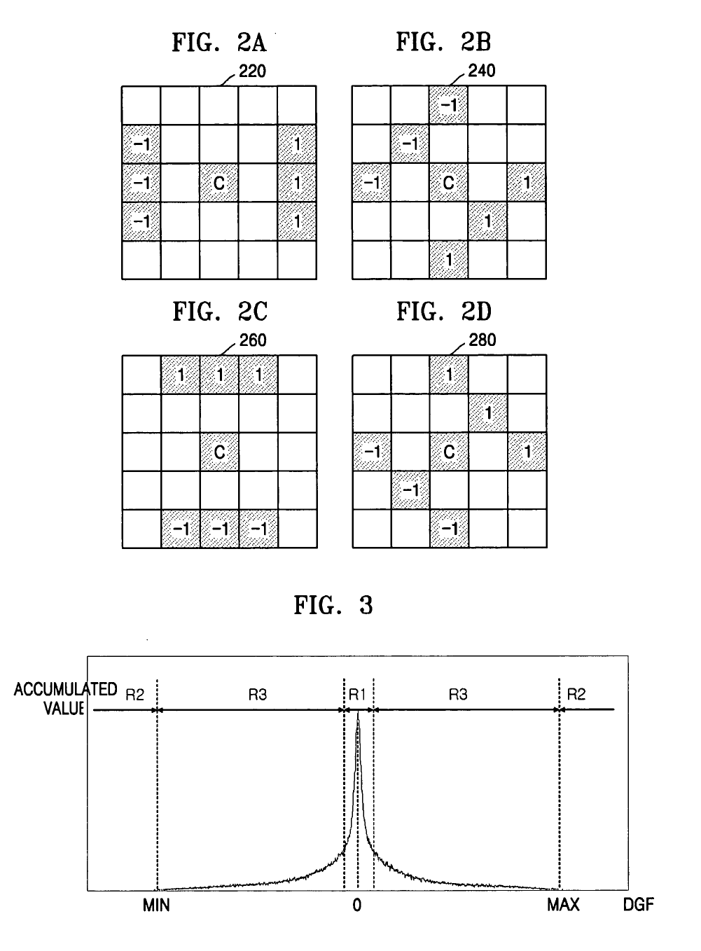

An example embodiment of the directional gradient filter unit 120 of FIG. 1 will now be described with reference to FIGS. 2(A)-2(D).

FIGS. 2(A), 2(B), 2(C) and 2(D) illustrate example directional gradient filters 220/240/260/280 corresponding to angular directions of 0°, 45°, 90°, and 135°, respectively, according to another example embodiment of the present invention. The following Equations 1-4 may correspond to the example embodiments illustrated in FIG. 2(A), 2(B), 2(C) and 2(D), respectively, where equations 1-4 may be given by

$$\begin{matrix}{DGF}_{0} ( x , y ) = {\sum }_{k = - m}^{m} \{ I ( x + d , y - k ) - I ( x - d , y - k ) \} & Equation 1 \\ {DGF}_{45} ( x , y ) = {\sum }_{k = - m}^{m} \{ I ( x + \frac{d}{2} + k , y + \frac{d}{2} - k ) - I ( x + \frac{d}{2} + k , y - \frac{d}{2} - k ) \} & Equation 2 \\ {DGF}_{90} ( x , y ) = {\sum }_{k = - m}^{m} \{ I ( x - k , y + d ) - I ( x - k , y - d ) \} & Equation 3 \\ {DGF}_{135} ( x , y ) = {\sum }_{k = - m}^{m} \{ I ( x - \frac{d}{2} + k , y + \frac{d}{2} - k ) - I ( x + \frac{d}{2} + k , y - \frac{d}{2} - k ) \} & Equation 4\end{matrix}$$

where a coordinate (x) may denote a horizontal position of a given pixel of the FIMG, a coordinate (y) may denote a vertical position of the given pixel of the FIMG, I(x, y) may denote a level of brightness of the given pixel at coordinate (x, y), DGF₀(x,y), DGF₄₅(x,y), DGF₉₀(x,y), and DGF₁₃₅(x,y) may denote a level of brightness of the given pixel at angular directions of 0°, 45°, 90°, and 135°, respectively, and a distance d may denote a distance between a center pixel C and a width (2m+1) of a filter (e.g. directional gradient filter 122, 124, 126, 128, etc.).

In the example embodiment of FIGS. 2(A), 2(B), 2(C) and 2(D), a variable m may equal 1 and the distance d may equal 2. Further, the directional gradient filters 220/240/260/280 may be represented as two sets of three pixels (e.g., −1, 1, etc.) and the center pixel C in a 5×5 pixel grid.

In the example embodiment of FIG. 2(A), the directional gradient filter 220 at an angular direction of 0° (expressed above in equation 1) may represent a difference of the brightness values of three “right-hand” side pixels (e.g., with values of 1) and three “left-hand” side pixels (e.g., with values of −1) with respect to the center pixel C. Accordingly, the directional gradient filter 220 in the 0° degree direction may represent a degree of change in the brightness value of a pixel in the 0° degree direction.

In the example embodiment of FIG. 2(B), the directional gradient filter 240 at an angular direction of 45° (expressed above in equation 2) may represent a difference of the brightness values of three “top-left” pixels and three “bottom-right” pixels in the 45° degree direction with respect to the center pixel C. Accordingly, the directional gradient filter 240 in the 45° degree direction may represent a degree of change in the brightness value of a pixel in the 45° degree direction.

In the example embodiment of FIG. 2(C), the directional gradient filter 260 at an angular direction of 90° (expressed above in equation 3) may represent a difference of the brightness values of three “top” pixels and three “bottom” pixels in the 90° degree direction with respect to the center pixel C. Accordingly, the directional gradient filter 260 in the 90° degree direction may represent a degree of change in the brightness value of a pixel in the 90° degree direction.

In the example embodiment of FIG. 2(D), the directional gradient filter 280 at an angular direction of 135° (expressed above in equation 4) may represent a difference of the brightness values of three “top-right” pixels and three “bottom-left” pixels in the 135° degree direction with respect to the center pixel C. Accordingly, the directional gradient filter 280 in the 135° degree direction may represent degree of change in the brightness value of a pixel in the 135° degree direction.

In another example embodiment of the present invention, the directional gradient filters 220/240/260/280 of FIGS. 2(A)-2(D) may correspond to the first/second/third/fourth directional gradient filters 122/124/126/128, respectively, of FIG. 1.

In the example embodiment of FIG. 1, the directional gradient images DGIMG1/DGIMG2/DGIMG3/DGIMG4 output by the first/second/third/fourth directional gradient filters 122/124/126/128, respectively, may indicate a degree of change in the brightness value among neighboring pixels at a plurality of angular directions (e.g., 0°, 45°, 90°, 135°, etc.).

In another example embodiment of the present invention, directional gradient filters 220/240/260/280, which may use equations 1-4, respectively, may output filtered values DGF1, DGF2, DGF3 and DGF4, respectively. In an example, if the difference of brightness values at a given angular direction is higher, the absolute value of the filtered values DGF1/DGF2/DGF3/DGF4 may be higher. Likewise, if the difference of brightness values at a given angular direction is lower, the filtered value DGF1/DGF2/DGF3/DGF4 may be lower (e.g., approximately zero).

In another example, there may be a lower brightness value difference among neighboring pixels in a background of a given fingerprint image. In another example, there may be an increased brightness value difference among neighboring pixels in a foreground of the given fingerprint image. If the absolute value of the filtered value DGF1/DGF2/DGF3/DGF4 is lower (e.g., approximately zero), there may be a higher probability that a corresponding center pixel is located in the background of the given fingerprint image. Likewise, if the absolute value of the filtered value DGF1/DGF2/DGF3/DGF4 is higher, there may be a higher probability that a corresponding center pixel is located in the foreground of the given fingerprint image.

In another example embodiment of the present invention, if noise (e.g., point noise) occurs in a fingerprint image, a brightness difference among neighboring pixels may be higher. Accordingly, if an absolute value of the filtered value DGF1/DGF2/DGF3/DGF4 is equal to or greater than a maximum threshold MAX or equal to or less than a minimum threshold MIN, there may be a higher probability that a corresponding center pixel may be located in a noise region. In an example, the maximum threshold MAX and the minimum threshold MIN may be values corresponding to the upper 1% and the lower 1%, respectively, of the filtered values DGF1/DGF2/DGF3/DGF4 obtained by filtering a number of pixels (e.g., all pixels) in a plurality of angular directions (e.g., 0°, 45°, 90°, 135°, etc). However, it is understood that values for the maximum threshold MAX and the minimum threshold MIN may be established in any well-known manner in other example embodiments of the present invention. For example, a user may set values for the thresholds MIN/MAX in another example embodiment of the present invention.

FIG. 3 illustrates a histogram of a directional gradient image according to another example embodiment of the present invention.

In the example embodiment of FIG. 3, in a horizontal direction, the histogram may represent a given value for one of the filtered values DGF1/DGF2/DGF3/DGF4. In a vertical direction, the histogram may represent a given number of the filtered values associated with the given value. The directional gradient images DGIMG1/DGIMG2/DGIMG3/DGIMG4 may be a cumulative distribution of the filtered values DGF1/DGF2/DGF3/DGF4 obtained by filtering a given number of pixels (e.g., all pixels) in a plurality of angular directions (e.g., 0°, 45°, 90°, 135°, etc.).

In the example embodiment of FIG. 3, the histogram may have a symmetrical distribution with respect to a value (e.g., a zero value) of the filtered values DGF. In other words, in an example where the histogram is symmetrical across the zero value, there may be approximately the same number of positive filtered values as negative filtered values. Further, as shown in FIG. 3, there may be a higher density of filtered values at the zero value for the filtered values DGF.

In the example embodiment of FIG. 3, the histogram may include regions R1, R2 and R3. In an example, the region R1 may correspond to a background of a given fingerprint image because the region R1 may include the filtered values DGF with absolute values relatively close to zero. The region R2 may correspond to a noise region because the region R2 may include filtered values higher than the maximum threshold MAX and/or less than the minimum threshold MIN. The region R3 may correspond to a foreground region because the region R3 may include filtered values higher than the maximum threshold MIN and/or lower than the minimum threshold MAX and may not approximate zero (e.g., as in the region R1). Differentiating between the foreground and the background of a given fingerprint image will be described in further detail below.

In another example embodiment of the present invention, brightness ranges may vary based on a type of fingerprint input apparatus receiving a given fingerprint. Thus, the directional gradient images associated with fingerprint images of the same finger may vary based at least in part on the type of fingerprint input apparatus.

In another example embodiment of the present invention, fingerprint images associated with the same finger may have different brightness ranges with respect to a humidity level of a fingerprint input apparatus. Thus, the directional gradient images of fingerprint images may vary based at least in part on a humidity level associated with a received fingerprint image.

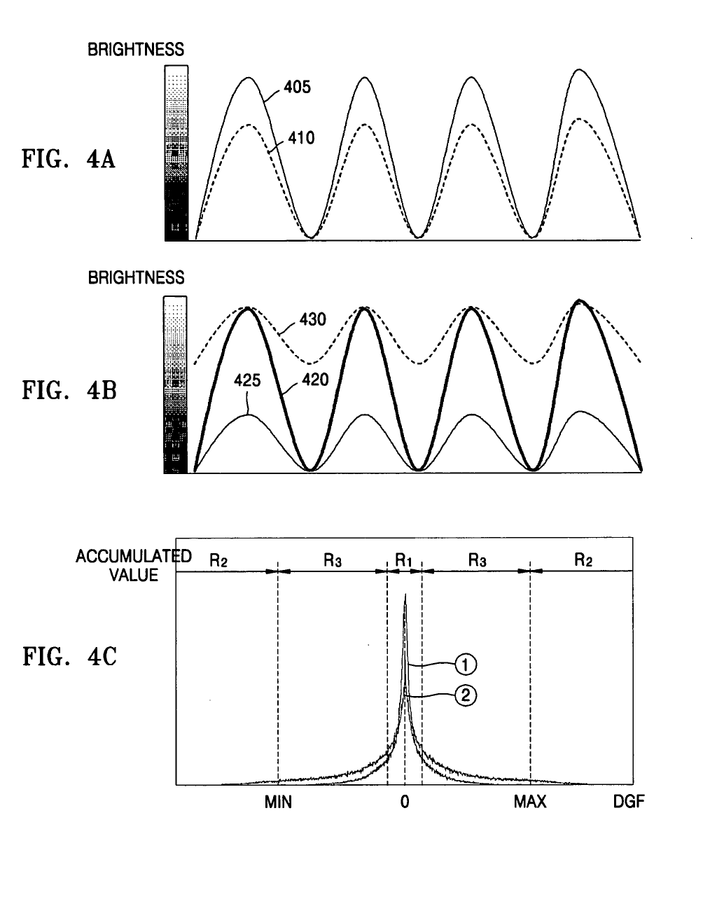

FIG. 4(A) illustrates a brightness distribution of a fingerprint image received from different fingerprint input apparatuses with the same humidity level according to another example embodiment of the present invention.

In the example embodiment of FIG. 4(A), a solid line 405 may indicate a brightness distribution of the given fingerprint image received from a first fingerprint input apparatus having a wider brightness region. A dotted line 410 may indicate the brightness distribution of the fingerprint image received from a second fingerprint input apparatus having a narrower brightness region.

In the example embodiment of FIG. 4(A), the solid line 405 and the dotted line 410 may show that different brightness distributions may be associated with the same fingerprint if different fingerprint input apparatuses are used.

FIG. 4(B) illustrates a brightness distribution of a given fingerprint image received from the same fingerprint input apparatus at different humidity levels according to another example embodiment of the present invention.

In the example embodiment of FIG. 4(B), a thick solid line 420 may indicate the brightness distribution of a fingerprint image received at a first humidity level. A thin solid line 425 may indicate the brightness distribution of the fingerprint image received at a second humidity level (e.g., a higher humidity level than the first humidity level). A dotted line 430 may indicate the brightness distribution of the fingerprint image input received at a third humidity level (e.g., a humidity level lower than the first and second humidity levels).

In the example embodiment of FIG. 4(B), brightness distributions shown by the thick solid line 420, the thin solid line 425 and the dotted line 430 may show that different brightness distributions may be associated with the same fingerprint received from the same fingerprint input apparatus at different humidity levels.

FIG. 4(C) illustrates a histogram comparing directional gradient images according to another example embodiment of the present invention.

In the example embodiment of FIGS. 1 and 4(C), the normalization unit 130 may generate normalized gradient images NDGIMG by normalizing directional gradient images DGIMG1/DGIMG2/DGIMG3/DGIMG4. The normalization unit 130 may normalize the directional gradient images DGIMG1/DGIMG2/DGIMG3/DGIMG4 in regions other than the region R2. In an example, absolute values of the filtered values may range from 0 to 255 in the regions R1 and R3. However, it is understood that other example embodiments of the present invention may include an adjusted range (e.g., an increased or decreased range).

In another example embodiment of the present invention, a normalization of the directional gradient images DGIMG1/DGIMG2/DGIMG3/DGIMG4 may be given as

$$NDGI θ ( x , y ) = \{ \begin{matrix}\frac{min - {DGF}_{θ} ( x , y )}{min} \times \frac{( A + 1 )}{2} , if {DGF}_{θ} ( x , y ) < 0 \\ \frac{max + {DGF}_{θ} ( x , y )}{max} \times \frac{( A + 1 )}{2} , otherwise\end{matrix} \qquad Equation 5$$

where NDGI(x,y) may denote a value obtained by normalizing the values DGF1/DGF2/DGF3/DGF4 filtered for a given pixel at a coordinate (x, y), angle θ may denote a given angular direction associated with one of the directional gradient filters 122/124/126/128, and a value A may denote an upper bound in a range for normalization. In the example embodiment of FIG. 4(C), the value A may equal 255.

An example embodiment of the normalization represented in Equation 5 will now be described in greater detail.

In the example embodiment of Equation 5, filtered values DGF1/DGF2/DGF3/DGF4, which may be distributed between the maximum threshold MAX and the minimum threshold MIN (e.g., as illustrated in FIG. 4(C)), may be normalized to be distributed in a given range. In an example, the maximum threshold MAX may correspond to the value A and the minimum threshold MIN may correspond to 0. Thus, in an example, if a filtered value equals zero (e.g., denoted as ‘filtered value (DGF)=0’), then equation 5 may be reduced to ‘NDGI=(A+1)/2’, and thereby the directional gradient images DGIMG may be normalized. By obtaining corresponding relationships between the filtered values (DGF) and the normalized values (NDGI (e.g., using Equation 5), the directional gradient images (DGIMG) may be normalized.

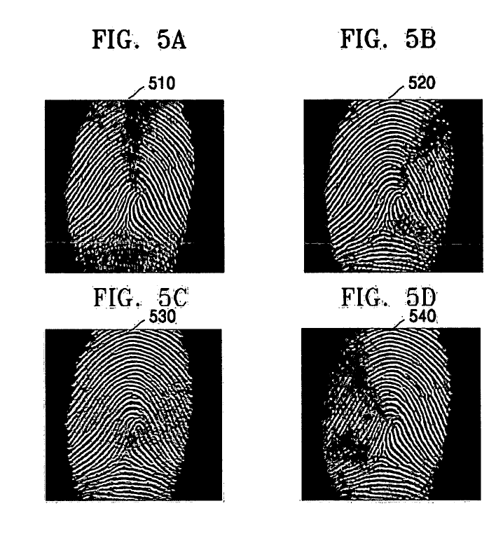

FIG. 5(A) illustrates a normalized directional gradient image 510 in a direction of 0° according to another example embodiment of the present invention.

FIG. 5(B) illustrates a normalized directional gradient image 520 in a direction of 45° according to another example embodiment of the present invention.

FIG. 5(C) illustrates a normalized directional gradient image 530 in a direction of 90° according to another example embodiment of the present invention.

FIG. 5(D) illustrates a normalized directional gradient image 540 in a direction of 135° according to another example embodiment of the present invention.

In the example embodiment of FIGS. 5(A), 5(B), 5(C) and 5(D), the normalized directional gradient image 510 may be clear (e.g., having portions with a higher probability of correctly characterizing as one of a foreground or a background) in the 0° degree direction, the normalized directional gradient image 520 may be clear in the 45° degree direction, the normalized directional gradient image 530 may be clear in the 90° degree direction and the normalized directional gradient image 540 may be clear in the 135° degree direction.

In the example embodiment of FIG. 1, the region classification unit 140 may divide the normalized directional gradient images NDGIMG1-NDGIMG4 into a plurality of blocks of a given size and may classify each of the plurality of blocks as being associated with one of the foreground and the background of the fingerprint image. The classifying of the plurality of blocks may be based at least in part on variance and symmetric coefficients of each of the plurality of blocks, as will be described later in greater detail.

In the example embodiment of FIG. 1, the region classification unit 140 may include a block segmenting unit 141, a variance calculation unit 143, a symmetrical coefficient calculation unit 145 and a region determination unit 147.

In the example embodiment of FIG. 1, the block segmenting unit 141 may divide the normalized directional gradient images NDGIMG1-NDGIMG4 into the plurality of blocks with the given size such that each of the plurality of blocks may include a pixel grid having m pixels by m pixels. The normalized directional gradient images NDGIMG1-NDGIMG4 may be divided into p blocks and q blocks in the width and length directions, respectively, of the fingerprint image. In an example, m may be equal to 16 and the block size may thereby be 16 pixels by 16 pixels. However, it is understood that other example embodiments of the present invention may employ other block sizes. Further, the number of pixels in for the length and/or width of the block need not be equal (e.g., a square pixel grid), and instead may include different numbers of pixels in the length and/or width directions of the pixel grid in other example embodiments of the present invention.

In the example embodiment of FIG. 1, the variance calculation unit 143 may obtain variances for a plurality (e.g., four) of angular directions (e.g., 0°, 45°, 90°, 135°) relative to each of the plurality of blocks. The variance calculation unit 143 may determine a maximum value from among the variances for the plurality of angular directions as the variance for a given block.

In the example embodiment of FIG. 1, a mean E of normalized values (NDGI) for each pixel at the plurality of angular directions for each of the plurality of blocks may be obtained with equation 6 (below) and the variance V of the normalized values (NDGI) of each pixel in the plurality of directions for each of the plurality of blocks may be obtained with equation 7 (below), which may be given as

$$\begin{matrix}{E}_{i} ( p , q ) = \frac{1}{mm} {\sum }_{x = pm + 1}^{pm + m} {\sum }_{y = qm + 1}^{qm + m} {NDGI}_{i} ( x , y ) & Equation 6 \\ {V}_{i} ( p , q ) = \frac{1}{mm} {\sum }_{x = pm + 1}^{pm + m} {\sum }_{y = qm + 1}^{qm + m} \{ {E}_{i} ( p , q ) - {NDGI}_{i} ( x , y ) ) & Equation 7\end{matrix}$$

where coordinate (p,q) may denote a position for one of the plurality of blocks in a normalized gradient image, and direction i may denote a given angular direction (e.g., 0°, 45°, 90°, 135°) of the directional gradient filter.

In the example embodiment of FIG. 1, the variance calculation unit 143 may use equations 6 and 7 to determine a maximum variance value for the plurality of angular directions analyzed by the directional gradient filters for a given block as the variance for the given block.

In the example embodiment of FIG. 1, the symmetrical coefficient calculation unit 145 may calculate the symmetrical coefficient of each of the plurality of blocks with equation 8, which will be discussed later in further detail. A symmetrical coefficient HS may be a ratio of the number of normalized values less than a central value in a normalized histogram distribution obtained by normalizing the histogram of FIG. 3 to the number of normalized values greater than the central value. In an example, the central value may be zero in the example histogram distribution of FIG. 3. In another example embodiment of the present invention, if the normalization unit 130 performs normalization within the range of 0 to 255, the central value may be 128. The symmetrical coefficient HS may be obtained by

$$HS ( p , q ) = \frac{\vert CHH ( p , q ) - CHL ( p , q ) \vert}{CHH ( p , q ) + CHL ( p , q )} \qquad Equation 8$$

where the coordinate (p,q) may denote a position for one of the plurality of blocks in a normalized gradient image, a first number CHL may denote the number of normalized values less than the central value and a second number CHH may denote the number of normalized values greater than the central value. The normalization coefficient HS may have a value between 0 and 1. In an example, the symmetry of the normalization coefficient HS may increase as the normalization coefficient HS approaches 0 and the symmetry may decrease as the normalization coefficient HS approaches 1.

In the example embodiment of FIG. 1, the region determination unit 147 may determine whether a given block may be associated with a foreground or a background by comparing the variance V (e.g., the maximum variance associated with the plurality of angular directions) and the symmetrical coefficient HS for the given block with a variance threshold TV and a symmetrical coefficient threshold THS.

In the example embodiment of FIG. 1, the variance threshold TV and the symmetrical coefficient threshold THS may be statistically determined using any well-known statistical method (e.g., a least-means-square (LMS) method) based on fingerprint images received from different environments (e.g., different fingerprint input apparatuses, different humidity levels, etc.).

In the example embodiment of FIG. 1, as discussed above, the brightness difference among pixels may be lower in the background of a fingerprint image as compared to the foreground of the fingerprint image. Thus, in the background, the variance may be lower and the symmetry may be lower. Likewise, in the foreground, the variance may be higher and the symmetry may be higher. The region determination unit 147 may classify each of the plurality of blocks as being associated with one of the foreground and background of a fingerprint image using the above-described characteristics associated with foregrounds and backgrounds.

In the example embodiment of FIG. 1, if the variance V for a given block is higher than the variance threshold TV and the symmetrical coefficient HS is less than the symmetrical coefficient threshold THS, the region determination unit 147 may determine the given block to be associated with a foreground region. In another example, if the above-described conditions for foreground classification are not satisfied for the given block, the region determination unit 147 may determine the given block to be associated with a background region.

In another example embodiment of the present invention, a fingerprint region may be segmented by normalizing a plurality of directional gradient images. Thus, threshold values (e.g., variance threshold TV, symmetrical coefficient threshold, etc.) need not be adjusted for different environments (e.g., different fingerprint input apparatuses, different humidity levels, etc.).

In the example embodiment of FIG. 1, the region classification unit 140 may not classify regions each of the plurality of blocks correctly under certain conditions. The post-processing unit 150 may compensate for classification errors of a given block using information related to blocks neighboring the given block.

In the example embodiment of FIG. 1, the post-processing unit 150 may use a median filtering method. In an example, by repeatedly median-filtering a fingerprint image, the post-processing unit 150 may generate a fingerprint image SEGIMG which may include corrections to errors in a received fingerprint image (e.g., from the region classification unit 140).

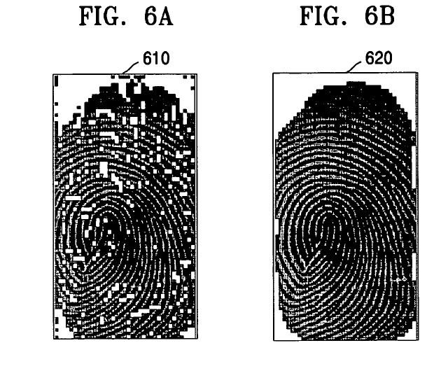

FIG. 6(A) illustrates a fingerprint image 610 prior to post-processing according to another example embodiment of the present invention.

FIG. 6(B) illustrates a resultant fingerprint image 620 after post-processing according to another example embodiment of the present invention.

In the example embodiment of FIG. 6(A), the fingerprint image 610 may include incorrectly classified blocks. For example, blocks associated with a background region may be incorrectly classified as being associated with a foreground region, and vice versa. The incorrect classifications may be represented by the white portions or holes in the foreground (e.g., ridges) of the fingerprint image 610 of FIG. 6(A).

In the example embodiment of FIG. 6(B), the white portions or holes evident in the foreground of the fingerprint image 610 of FIG. 6(A) may be corrected by post processing (e.g., performed by the post-processing unit 150 of FIG. 1) as shown in the resultant fingerprint image 620 of FIG. 6(B).

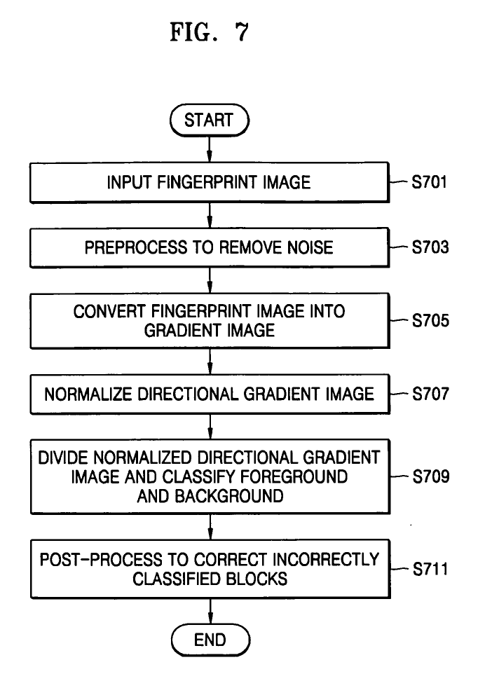

FIG. 7 is a flowchart of a fingerprint region segmentation process according to another example embodiment of the present invention.

In the example embodiment of FIG. 7, an input fingerprint image may be received from a fingerprint input apparatus (at S710). The input fingerprint image may include a noise component as well as fingerprint information. The noise component of the input fingerprint image may be reduced by preprocessing (at S703) to generate a noise reduced fingerprint image. In an example, the preprocessing (at S703) may include a Gaussian-filtering of the noise component of the input fingerprint image.

In the example embodiment of FIG. 7, the noise reduced fingerprint image may be filtered in a given number (e.g., four) of angular directions (e.g., 0°, 45°, 90°, 135°) and may be converted into a plurality of directional gradient images (at S705). For example, the noise reduced fingerprint image may be converted into the plurality of directional gradient images by filtering the brightness difference in each pixel in the given number of angular directions (e.g., 0°, 45°, 90°, 135°) with the directional gradients. In another example, the brightness difference for each pixel in the given number of angular directions may be expressed as above-described equations 1-4.

In the example embodiment of FIG. 7, the plurality of directional gradient images may be normalized (at S707) to generate a plurality of normalized directional gradient images (e.g., for different environments associated with the input fingerprint image). The normalization may include converting the plurality of directional gradient images into values in a given range (e.g., from 0 to A), where the brightness difference for each pixel of the plurality of directional gradient images may be normalized. The normalized brightness difference may be expressed in the above-described equation 5.

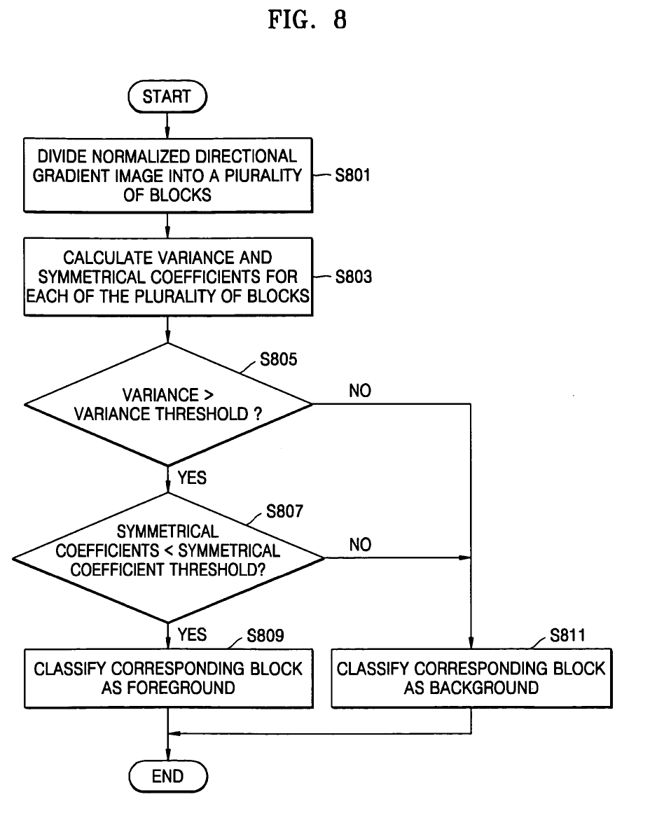

In the example embodiment of FIG. 7, the normalized directional gradient images may be divided into a plurality of blocks and may be classified into one of a foreground and a background (at S709) to generate a classified fingerprint image. The classification (at S709) will be described in greater detail below with reference to FIG. 8.

In the example embodiment of FIG. 7, the classified fingerprint image may be post-processed (at S711) to remove incorrect classifications (e.g., related to the foreground, background, etc.) of the plurality of blocks. For example, the post-processing (at S711) may include repeatedly performing a median-filtering of the fingerprint image.

FIG. 8 is a flowchart of a classification process according to another example embodiment of the present invention.

In the example embodiment of FIG. 8, the plurality of normalized directional gradient images (generated at S707) may be divided into a plurality of blocks having a given size (at S801). In an example, the given size may include 256 pixels in a pixel grid having a width of 16 pixels and a length of 16 pixels.

In the example embodiment of FIG. 8, the variance of the normalized brightness differences and the symmetrical coefficient of the brightness difference for each of the plurality of blocks may be calculated (at S803). For example, the variance for each of the plurality of blocks may be determined as the maximum value among variances at a given number of angular directions for a corresponding block. The variances among the given number of angular directions may be calculated (e.g., using equation 7) based on a mean of the normalized brightness differences (e.g., calculated using equation 6). The symmetrical coefficient for each of the plurality of blocks may be a ratio of the number of normalized brightness differences greater than the central value of the normalized brightness differences to the number of normalized brightness differences less than the central value. The symmetrical coefficient may be expressed as above-described equation 8. The classification (e.g., into one of a foreground or background) for each of the plurality of blocks may be based at least in part on the variance and symmetrical coefficient for a corresponding block.

In the example embodiment of FIG. 8, the calculated variance for each of the plurality of blocks may be compared to the variance threshold (at S805). If the calculated variance is greater than the variance threshold (at S805), the symmetrical coefficient may be compared to the symmetrical coefficient threshold (at S807). If the symmetrical coefficient is less than the symmetrical coefficient threshold (at S807), the given one of the plurality of blocks may be classified as being associated with the foreground of a fingerprint image (at S809). Alternatively, if the comparison (at S805) indicates the variance is not greater than the variance threshold or the comparison (at S807) indicates the symmetrical coefficient is not less than the symmetrical coefficient threshold, the given one of the plurality of blocks may be classified as being associated with the background of the fingerprint image (at S811). In another example, the operations described above with respect to S803/S805/S807/S809/S811 may be repeated for each of the plurality of blocks.

Although described primarily in terms of hardware above, the example methodology implemented by one or more components of the example system described above may also be embodied in software as a computer program. For example, a program in accordance with the example embodiments of the present invention may be a computer program product causing a computer to execute a method of segmenting a fingerprint image into a plurality of regions, as described above.

The computer program product may include a computer-readable medium having computer program logic or code portions embodied thereon for enabling a processor of the system to perform one or more functions in accordance with the example methodology described above. The computer program logic may thus cause the processor to perform the example method, or one or more functions of the example method described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAM, ROM, flash memories and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal embodied in a carrier wave. The computer data signal embodying one or more instructions or functions of the example methodology may be carried on a carrier wave for transmission and/or reception by an entity that executes the instructions or functions of the example methodology. For example, the functions or instructions of the example method may be implemented by processing one or more code segments of the carrier wave in a computer controlling one or more of the components of the example apparatus 100 of FIGS. 1, where instructions or functions may be executed for segmenting a fingerprint image, in accordance with the example method outlined in any of FIGS. 7 and 8.

Further, such programs, when recorded on computer-readable storage media, may be readily stored and distributed. The storage medium, as it is read by a computer, may enable the processing of multimedia data signals prevention of copying these signals, allocation of multimedia data signals within an apparatus configured to process the signals, and/or the reduction of communication overhead in an apparatus configured to process multiple multimedia data signals, in accordance with the example method described herein.

Example embodiments of the present invention being thus described, it will be obvious that the same may be varied in many ways. For example, while above-described example embodiments include four directional gradient filters corresponding to four angular directions, it is understood that other example embodiments of the present invention may include any number of directional gradient filters and/or angular directions. Further, while above-described example embodiments are illustrated with a symmetrical distribution (e.g., in FIGS. 3 and 4(C)) over a zero value, it is understood that other example embodiments of the present invention may include an asymmetrical distribution and/or a symmetrical distribution with respect to another value (e.g., not zero). Further, while example equations are given above to explain calculations of parameters (e.g., mean, variance, etc.), it is understood that any well-known equations and/or methods for generating the parameters may be used in other example embodiments of the present invention.

Further, the example embodiment illustrated in FIG. 1 is not limited to processing an input fingerprint image in four angular directions, but rather may process the input fingerprint image in any number of angular directions. Likewise, each of the preprocessing unit 110, directional gradient filter unit 120, normalization unit 130, region classification unit 140 and post-processing unit 150 may be configured so as to process signals corresponding to any number of angular directions, regions, etc.

Further, while above-described as directional gradient filters 122/124/126/128/220/240/260/280, it is understood that in other example embodiments of the present any directional filter may be employed. Likewise, while above-described as directional gradient images, it is understood that in other example embodiments any directional image may be generated by other example directional filters.

Such variations are not to be regarded as departure from the spirit and scope of example embodiments of the present invention, and all such modifications as would be obvious to one skilled in the art are intended to be included within the scope of the following claims.

What is claimed is:

1. A fingerprint region segmenting apparatus, comprising:
a directional filter unit receiving an input fingerprint image and filtering the input fingerprint image to generate at least one directional image;
a normalization unit normalizing the at least one directional image; and
a region classification unit dividing the normalized at least one directional image into a plurality of blocks and classifying each of the plurality of blocks.

2. The fingerprint region segmenting apparatus of claim 1, further comprising:
a pre-processing unit for reducing noise in the input fingerprint image.

3. The fingerprint region segmenting apparatus of claim 1, wherein the one directional filter unit includes a plurality of directional filters and the at least one directional image includes a plurality of directional images.

4. The fingerprint region segmenting apparatus of claim 3, wherein the plurality of directional filters filters the input fingerprint image at a plurality of angular directions.

5. The fingerprint region segmenting apparatus of claim 4, wherein each of the plurality of directional filters filters the input fingerprint image at a different one of the plurality of angular directions.

6. The fingerprint region segmenting apparatus of claim 1, wherein the region classification unit classifies based at least in part on variances and symmetrical coefficients associated with the plurality of blocks.

7. The fingerprint region segmenting apparatus of claim 1, wherein the region classification unit classifies each of the plurality of blocks as being associated with one of a foreground of the input fingerprint image and a background of the input fingerprint image.

8. The fingerprint region segmenting apparatus of claim 4, wherein the plurality of angular directions includes at least one of 0°, 45°, 90°, and 135°.

9. The fingerprint region segmenting apparatus of claim 4, wherein the plurality of angular directions include a first angular direction, a second angular direction, a third angular direction and a fourth angular direction, wherein a brightness difference between pixels in the input fingerprint image for the first, second, third and fourth angular directions may be represented respectively as
$$\begin{matrix}{DGF}_{0} ( x , y ) = {\sum }_{k = - m}^{m} \{ I ( x + d , y - k ) - I ( x - d , y - k ) \} \\ {DGF}_{45} ( x , y ) = {\sum }_{k = - m}^{m} \{ I ( x + \frac{d}{2} + k , y + \frac{d}{2} - k ) - I ( x + \frac{d}{2} + k , y - \frac{d}{2} - k ) \} \\ {DGF}_{90} ( x , y ) = {\sum }_{k = - m}^{m} \{ I ( x - k , y + d ) - I ( x - k , y - d ) \} \\ {DGF}_{135} ( x , y ) = {\sum }_{k = - m}^{m} \{ I ( x - \frac{d}{2} + k , y + \frac{d}{2} - k ) - I ( x + \frac{d}{2} + k , y - \frac{d}{2} - k ) \}\end{matrix}$$
where DGF₀, DGF₄₅, DGF₉₀, and DGF₁₃₅ denote the brightness differences in angular directions of 0°, 45°, 90°, and 135°, respectively, coordinate (x,y) denotes coordinates indicating the position of the pixel in the directional image, and d denotes a distance from the pixel and (2m+1) denotes the width of a corresponding directional filter.

10. The fingerprint region segmenting apparatus of claim 9, wherein m equals 1 and d equals 2.

11. The fingerprint region segmenting apparatus of claim 1, wherein the normalization unit generates the normalized at least one directional image by normalizing brightness differences of each pixel of the at least one directional image into values in a given range.

12. The fingerprint region segmenting apparatus of claim 11, wherein the given range ranges from 0 to A, and the normalized brightness difference is expressed as
$$NDGI θ ( x , y ) = \{ \begin{matrix}\frac{min - {DGF}_{θ} ( x , y )}{min} \times \frac{( A + 1 )}{2} , if {DGF}_{θ} ( x , y ) < 0 \\ \frac{max + {DGF}_{θ} ( x , y )}{max} \times \frac{( A + 1 )}{2} , otherwise\end{matrix}$$
where NDGI denotes the normalized brightness difference, min denotes a brightness difference corresponding to a lowest 1% from among a brightness distribution, θ denotes one of a plurality of angular directions associated with the at least one directional filter, and max denotes the brightness difference corresponding to a highest 1% among the brightness distribution.

13. The fingerprint region segmenting apparatus of claim 12, wherein A equals 255.

14. The fingerprint region segmenting apparatus of claim 1, wherein the region classification unit includes:
a block segmenting unit dividing the normalized directional image into the plurality of blocks, each of the plurality of blocks having a given size;
a variance calculation unit calculating a first variance of normalized brightness differences in each of the plurality of blocks;
a symmetrical coefficient calculation unit calculating a symmetrical coefficient of the normalized brightness difference in each of the plurality of blocks; and
a region determination unit determining a classification associated with each of the plurality of blocks based at least in part on the calculated first variance and the calculated symmetrical coefficient.

15. The fingerprint region segmenting apparatus of claim 14, wherein the variance calculation unit calculates a mean of the normalized brightness differences at a plurality of angular directions for each of the plurality of blocks, calculates a second variance of the normalized brightness differences at the plurality of angular directions for each of the plurality of blocks and selects a maximum value among the calculated second variances at the plurality of angular directions as the first variance for one of the plurality of blocks.

16. The fingerprint region segmenting apparatus of claim 15, wherein the mean is expressed as
$${E}_{i} ( p , q ) = \frac{1}{mm} {\sum }_{x = pm + 1}^{pm + m} {\sum }_{y = qm + 1}^{qm + m} {NDGI}_{i} ( x , y )$$
where coordinate (p,q) denotes a position of one of the plurality of blocks in the normalized at least one image and i denotes one of the plurality of angular directions.

17. The fingerprint region segmenting apparatus of claim 15, wherein the second variance is expressed as
$${V}_{i} ( p , q ) = \frac{1}{mm} {\sum }_{x = pm + 1}^{pm + m} {\sum }_{y = qm + 1}^{qm + m} \{ {E}_{i} ( p , q ) - {NDGI}_{i} ( x , y )$$
where coordinate (p,q) denotes a position of one of the plurality of blocks in the normalized at least one image and i denotes one of the plurality of angular directions.

18. The fingerprint region segmenting apparatus of claim 14, wherein the symmetrical coefficient calculation unit calculates the symmetrical coefficient for each of the plurality of blocks based on a ratio of a number of the normalized brightness differences greater than a central value in a brightness distribution to a number of the normalized brightness differences less than the central value in the brightness distribution.

19. The fingerprint region segmenting apparatus of claim 18, wherein the symmetrical coefficient is expressed as
$$HS ( p , q ) = \frac{\vert CHH ( p , q ) - CHL ( p , q ) \vert}{CHH ( p , q ) + CHL ( p , q )}$$
where coordinate (p,q) denotes a position of one of the plurality of blocks in the normalized at least one image, CHL denotes the number of normalized brightness differences less than the central value in the brightness distribution, and CHH denotes the number of normalized brightness differences greater than the central value in the brightness distribution.

20. The method of claim 14, wherein the region determination unit classifies a given block as associated with a foreground of the input fingerprint image if the variance is greater than a variance threshold and the symmetrical coefficient is less than a symmetrical coefficient threshold and classifies the given block as associated with a background of the input fingerprint image if the variance is not greater than a variance threshold and the symmetrical coefficient is not less than a symmetrical coefficient threshold.

21. The fingerprint region segmenting apparatus of claim 14, further comprising:
a preprocessing unit reducing noise in the input fingerprint image.

22. The fingerprint region segmenting apparatus of claim 21, wherein the preprocessing unit reduces the noise with a Gaussian-filtering process.

23. The fingerprint region segmenting apparatus of claim 1, further comprising:
a post-processing unit correcting a classification for at least one incorrectly classified block from among the plurality of blocks.

24. The fingerprint region segmenting apparatus of claim 23, wherein the at least one corrected block is initially classified incorrectly by the region classification unit.

25. The fingerprint region segmenting apparatus of claim 24, wherein the post-processing unit corrects the at least one incorrectly classified block by repeatedly median-filtering the fingerprint image in which the incorrectly classified block is classified.

26. A method of segmenting a fingerprint image, comprising:
filtering an input fingerprint image to generate at least one directional image;
normalizing the at least one directional image;
dividing the at least one normalized directional image into a plurality of blocks; and
classifying each of the plurality of blocks.

27. The method of claim 26, further comprising:
preprocessing the input fingerprint image to reduce noise before the filtering.

28. The method of claim 27, wherein the filtering filters the input fingerprint image at a plurality of angular directions.

29. The method of claim 27, wherein the dividing is based at least in part on a variance and a symmetrical coefficient of each of the plurality of blocks.

30. The method of claim 27, wherein the classifying classifies each of the plurality of blocks as being associated with one of a foreground of the input fingerprint image and a background of the input fingerprint image.

31. The method of claim 28, wherein the plurality of angular directions include at least one of 0°, 45°, 90°, and 135°.

32. The method of claim 28, wherein the plurality of angular directions include a first angular direction, a second angular direction, a third angular direction and a fourth angular direction, wherein a brightness difference between pixels in the input fingerprint image for the first, second, third and fourth angular directions may be represented respectively as
$$\begin{matrix}{DGF}_{0} ( x , y ) = {\sum }_{k = - m}^{m} \{ I ( x + d , y - k ) - I ( x - d , y - k ) \} \\ {DGF}_{45} ( x , y ) = {\sum }_{k = - m}^{m} \{ I ( x + \frac{d}{2} + k , y + \frac{d}{2} - k ) - I ( x + \frac{d}{2} + k , y - \frac{d}{2} - k ) \} \\ {DGF}_{90} ( x , y ) = {\sum }_{k = - m}^{m} \{ I ( x - k , y + d ) - I ( x - k , y - d ) \} \\ {DGF}_{135} ( x , y ) = {\sum }_{k = - m}^{m} \{ I ( x - \frac{d}{2} + k , y + \frac{d}{2} - k ) - I ( x + \frac{d}{2} + k , y - \frac{d}{2} - k ) \}\end{matrix}$$
where DGF₀, DGF₄₅, DGF₉₀, and DGF₁₃₅ denote the brightness differences in angular directions 0°, 45°, 90°, and 135°, respectively, coordinate (x,y) denotes coordinates indicating the position of the pixel in the directional image, and d denotes a distance from the pixel and (2m+1) denotes the width of a corresponding directional filter.

33. The method of claim 32, wherein m equals 1 and d equals 2.

34. The method of claim 26, wherein the normalizing includes normalizing brightness differences of each pixel of the at least one directional image into values in a given range.

35. The fingerprint region segmenting apparatus of claim 34, wherein the given range ranges from 0 to A, and the normalized brightness difference is expressed as
$$NDGI θ ( x , y ) = \{ \begin{matrix}\frac{min - {DGF}_{θ} ( x , y )}{min} \times \frac{( A + 1 )}{2} , & {ifDGF}_{θ} ( x , y ) < 0 \\ \frac{max + {DGF}_{θ} ( x , y )}{max} \times \frac{( A + 1 )}{2} , & otherwise\end{matrix}$$
where NDGI denotes the normalized brightness difference, min denotes a brightness difference corresponding to a lowest 1% from among a brightness distribution, θ denotes one of a plurality of angular directions associated with the at least one directional filter, and max denotes the brightness difference corresponding to a highest 1% from among the brightness distribution.

36. The method of claim 35, wherein A equals 255.

37. The method of claim 26, wherein the classifying includes:
dividing the at least one normalized directional image into the plurality of blocks, each of the plurality of blocks having a given size;
calculating a first variance of a normalized brightness differences for each of the plurality of blocks;
calculating a symmetrical coefficient of the brightness difference for each of the plurality of blocks; and
determining whether a classification associated with each of the plurality of blocks based on the calculated first variance and the calculated symmetrical coefficient.

38. The method of claim 37, wherein the calculating of the first variance includes:
calculating a mean of the normalized brightness differences at a plurality of angular directions for each of the plurality of blocks;
calculating a second variance of the normalized brightness differences at the plurality of angular directions for each of the plurality of blocks; and
selecting a maximum value among the calculated second variances at the plurality of angular directions as the first variance for one of the plurality of blocks.

39. The method of claim 37, wherein the mean is expressed as
$${E}_{i} ( p , q ) = \frac{1}{mm} {\sum }_{x = pm + 1}^{pm + m} {\sum }_{y = qm + 1}^{qm + m} {NDGI}_{i} ( x , y )$$
where coordinate (p,q) denotes a position of one of the plurality of blocks in the normalized at least one image and i denotes one of the plurality of angular directions.

40. The method of claim 37, wherein the second variance is expressed as
$${V}_{i} ( p , q ) = \frac{1}{m m} {\sum }_{x = pm + 1}^{pm + m} {\sum }_{y = qm + 1}^{qm + m} \{ {E}_{i} ( p , q ) - {NDGI}_{i} ( x , y )$$
where coordinate (p,q) denotes a position of one of the plurality of blocks in the normalized at least one image and i denotes one of the plurality of angular directions.

41. The method of claim 37, wherein the calculating of the symmetrical coefficient includes is based on a ratio of a number of the normalized brightness differences greater than a central value to a number of the normalized brightness differences less than the central value.

42. The method of claim 37, wherein the symmetrical coefficient is expressed as
$$HS ( p , q ) = \frac{\vert CHH ( p , q ) - CHL ( p , q ) \vert}{CHH ( p , q ) + CHL ( p , q )}$$
where coordinate (p,q) denotes a position of one of the plurality of blocks in the normalized at least one image, CHL denotes the number of normalized brightness differences less than the central value and CHH denotes the number of normalized brightness differences greater than the central value.

43. The method of claim 37, wherein the classifying classified a given block as associated with a foreground of the input fingerprint image if the variance is greater than a variance threshold and the symmetrical coefficient is less than a symmetrical coefficient threshold.

44. The method of claim 37, wherein the classifying classified a given block as associated with a background of the input fingerprint image if the variance is not greater than a variance threshold and the symmetrical coefficient is not less than a symmetrical coefficient threshold.

45. The method of claim 27, wherein the preprocessing is performed before the at least one directional image is generated.

46. The method of claim 27, wherein the preprocessing includes a Gaussian-filtering process.

47. The method of claim 26, wherein the classifying classifies at least one of the plurality of blocks incorrectly.

48. The method of claim 47, further comprising:
correcting the classification of the at least one incorrectly classified block.

49. The method of claim 48, wherein the correcting includes applying a median-filtering process repeatedly.
